(19) United States
(12) Patent Application Publication
(10) Pub. No.: US 2026/0231143 A1
(43) Pub. Date: Aug. 6, 2026

(54) UPLINK MULTI-USER SCHEDULING IN MU-MIMO SYSTEMS USING REINFORCEMENT LEARNING

(71) Applicant: Nokia Solutions and Networks Oy, Espoo (FI)

(72) Inventors: Ravi Sharan BHAGAVATHULA ANANTHA GOPALA, Massy (FR); Pavan KOTESHWAR SRINATH, Massy (FR); Alvaro VALCARCE RIAL, Massy (FR)

(21) Appl. No.: 19/152,522

(22) PCT Filed: Jan. 31, 2023
(86) PCT No.: PCT/EP2023/052347

§ 371 Date: Jul. 31, 2025

(51) Int. Cl. H04W 72/1263; H04L 1/00; H04L 41/16

(52) U.S. Cl. CPC H04W 72/1263; H04L 1/0003; H04L 41/16

(57) ABSTRACT

There is provided an apparatus for a distributed unit comprising means for determining a state vector for a given time slot for a given cell, means for determining a predicted number of spatial layers for a plurality of user equipments for the given time slot based on the determined state vector, means for determining a set of the plurality of user equipments based on the predicted number of spatial layers and the determined state vector, means for co-scheduling the determined set of the plurality of user equipments, means for receiving data from the plurality of co-scheduled user equipments and means for determining a reward metric based on the number of correctly received bits from the plurality of co-scheduled user equipments and a set of hyper-parameters.

### FIELD

The present application relates to a method, apparatus, system and computer program and in particular but not exclusively to a method and apparatus for uplink multi-user scheduling in extreme MIMO systems using reinforcement learning.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus for a distributed unit comprising means for determining a state vector for a given time slot for a given cell, means for determining a predicted number of spatial layers for a plurality of user equipments for the given time slot based on the determined state vector, means for determining a set of the plurality of user equipments based on the predicted number of spatial layers and the determined state vector, means for co-scheduling the determined set of the plurality of user equipments, means for receiving data from the plurality of co-scheduled user equipments and means for determining a reward metric based on the number of correctly received bits from the plurality of co-scheduled user equipments and a set of hyper-parameters.

The state vector may comprises an indication of at least one of channel state representation, inter-user correlation matrix distance, age of transmission values for the plurality of user equipments and buffer status reports for the plurality of user equipments.

The age of transmission value may define a time period since the last data packet to be transmitted by a UE was generated.

The apparatus may comprise means for updating the set of hyper-parameters at the distributed unit per time slot.

The apparatus may comprise means for providing, per τ time slots, the determined state vectors, the determined reward metrics and an indication of the determined set of the plurality of user equipments for τ given time slots to a centralised unit, wherein τ is a positive integer; and means for receiving, per τ time slots, an updated set of hyper-parameters from the centralised unit, wherein the updated set of hyper-parameters is based on the determined state vectors, the determined reward metrics and determined set of the plurality of co-scheduled user equipments provided to the centralised unit.

The means for determining the predicted number of spatial layers may comprise a machine learning model which, when executed, is configured to determine the predicted number of spatial layers for the given time slot based on the determined state vector for the plurality of user equipments.

The machine learning model may comprise a neural network.

The means for determining the set of the plurality of user equipments may comprise a machine learning model which, when executed, is configured to determine the set of user equipments based on the predicted number of spatial layers and the determined state vector.

The machine learning model comprises a recurrent neural network or a gated recurrent unit.

The machine learning model may comprise a two-stage neural network architecture with a feed forward network determining the spatial stream selection in the first stage followed by a recurrent neural network realised as a custom gated recurrent unit in the second stage determining the set of the plurality of user equipments.

The determined state vector and the determined reward metric may be used as training data for the machine learning model.

Means for co-scheduling the determined set of the plurality of user equipments may comprise means for determining a modulation and coding scheme for the determined set of user equipments and means for requesting the co-scheduled user equipments use the determined modulation and coding scheme.

In a second aspect there is provided an apparatus for a centralised unit comprising means for receiving at the centralised unit from a plurality of distributed units, per τ time slots, state vectors, reward metrics and an indication of a set of a plurality of co-scheduled user equipments determined at the distributed unit for τ given time slots, wherein τ is a positive integer, means for determining an updated set of hyper-parameters at the centralised unit based on the received state vectors, the received reward metrics and received set of the plurality of co-scheduled user equipments and means for providing, per τ time slots, the updated set of hyper-parameters from the centralised unit to the plurality of distributed units. In a third aspect there is provided a method comprising, at a distributed unit, determining a state vector for a given time slot for a given cell, determining a predicted number of spatial layers for a plurality of user equipments for the given time slot based on the determined state vector, determining a set of the plurality of user equipments based on the predicted number of spatial layers and the determined state vector, co-scheduling the determined set of the plurality of user equipments, receiving data from the plurality of co-scheduled user equipments and determining a reward metric based on the number of correctly received bits from the plurality of co-scheduled user equipments and a set of hyper-parameters.

The state vector may comprises an indication of at least one of channel state representation, inter-user correlation matrix distance, age of transmission values for the plurality of user equipments and buffer status reports for the plurality of user equipments.

The age of transmission value may define a time period since the last data packet to be transmitted by a UE was generated.

The method may comprise updating the set of hyper-parameters at the distributed unit per time slot.

The method may comprise providing, per τ time slots, the determined state vectors, the determined reward metrics and an indication of the determined set of the plurality of user equipments for τ given time slots to a centralised unit, wherein τ is a positive integer; and receiving, per τ time slots, an updated set of hyper-parameters from the centralised unit, wherein the updated set of hyper-parameters is based on the determined state vectors, the determined reward metrics and determined set of the plurality of co-scheduled user equipments provided to the centralised unit.

Determining the predicted number of spatial layers may comprise a machine learning model which, when executed, is configured to determine the predicted number of spatial layers for the given time slot based on the determined state vector for the plurality of user equipments.

The machine learning model may comprise a neural network.

Determining the set of the plurality of user equipments may comprise a machine learning model which, when executed, is configured to determine the set of user equipments based on the predicted number of spatial layers and the determined state vector.

The machine learning model may comprise a recurrent neural network or a gated recurrent unit.

The machine learning model may comprise a two-stage neural network architecture with a feed forward network determining the spatial stream selection in the first stage followed by a recurrent neural network realised as a custom gated recurrent unit in the second stage determining the set of the plurality of user equipments.

The determined state vector and the determined reward metric may be used as training data for the machine learning model.

Co-scheduling the determined set of the plurality of user equipments may comprise determining a modulation and coding scheme for the determined set of user equipments and requesting the co-scheduled user equipments use the determined modulation and coding scheme.

In a fourth aspect there is provided a method comprising, at a centralised unit, receiving at the centralised unit from a plurality of distributed units, per τ time slots, state vectors, reward metrics and an indication of a set of a plurality of user equipments determined at the distributed unit for τ given time slots, wherein τ is a positive integer, determining an updated set of hyper-parameters at the centralised unit based on the received state vectors, the received reward metrics and received set of the plurality of user equipments and providing, per τ time slots, the updated set of hyper-parameters from the centralised unit to the plurality of distributed units.

In a fifth aspect there is provided an apparatus comprising: at least one processor and at least one memory storing instructions that, when executed by the at least one processor, cause the apparatus at least to, at a distributed unit, determine a state vector for a given time slot for a given cell, determine a predicted number of spatial layers for a plurality of user equipments for the given time slot based on the determined state vector, determine a set of the plurality of user equipments based on the predicted number of spatial layers and the determined state vector, co-schedule the determined set of the plurality of user equipments, receive data from the plurality of co-scheduled user equipments and determine a reward metric based on the number of correctly received bits from the plurality of co-scheduled user equipments and a set of hyper-parameters.

The state vector may comprises an indication of at least one of channel state representation, inter-user correlation matrix distance, age of transmission values for the plurality of user equipments and buffer status reports for the plurality of user equipments.

The age of transmission value may define a time period since the last data packet to be transmitted by a UE was generated.

The apparatus may be caused to update the set of hyper-parameters at the distributed unit per time slot.

The apparatus may be caused to provide, per τ time slots, the determined state vectors, the determined reward metrics and an indication of the determined set of the plurality of user equipments for τ given time slots to a centralised unit, wherein τ is a positive integer; and receive, per τ time slots, an updated set of hyper-parameters from the centralised unit, wherein the updated set of hyper-parameters is based on the determined state vectors, the determined reward metrics and determined set of the plurality of co-scheduled user equipments provided to the centralised unit.

The apparatus may comprise a machine learning model which, when executed, is configured to determine the predicted number of spatial layers for the given time slot based on the determined state vector for the plurality of user equipments.

The machine learning model may comprise a neural network.

The apparatus may comprise a machine learning model which, when executed, is configured to determine the set of user equipments based on the predicted number of spatial layers and the determined state vector.

The machine learning model may comprise a recurrent neural network or a gated recurrent unit.

The machine learning model may comprise a two-stage neural network architecture with a feed forward network determining the spatial stream selection in the first stage followed by a recurrent neural network realised as a custom gated recurrent unit in the second stage determining the set of the plurality of user equipments.

The determined state vector and the determined reward metric may be used as training data for the machine learning model.

The apparatus may be caused to determine a modulation and coding scheme for the determined set of user equipments and request the co-scheduled user equipments use the determined modulation and coding scheme.

In a sixth aspect there is provided an apparatus comprising: at least one processor and at least one memory storing instructions that, when executed by the at least one processor, cause the apparatus at least to, at a centralised unit, receive at the centralised unit from a plurality of distributed units, per τ time slots, state vectors, reward metrics and an indication of a set of a plurality of user equipments determined at the distributed unit for τ given time slots, wherein τ is a positive integer, determine an updated set of hyper-parameters at the centralised unit based on the received state vectors, the received reward metrics and received set of the plurality of user equipments and provide, per τ time slots, the updated set of hyper-parameters from the centralised unit to the plurality of distributed units.

In a seventh aspect there is provided a computer readable medium comprising instructions which, when executed by an apparatus, cause the apparatus to perform at least the following, at a distributed unit, determining a state vector for a given time slot for a given cell, determining a predicted number of spatial layers for a plurality of user equipments for the given time slot based on the determined state vector, determining a set of the plurality of user equipments based on the predicted number of spatial layers and the determined state vector, co-scheduling the determined set of the plurality of user equipments, receiving data from the plurality of co-scheduled user equipments and determining a reward metric based on the number of correctly received bits from the plurality of co-scheduled user equipments and a set of hyper-parameters.

In an eighth aspect there is provided a computer readable medium comprising instructions which, when executed by an apparatus, cause the apparatus to perform at least the following, at a centralised unit, receiving at the centralised unit from a plurality of distributed units, per τ time slots, state vectors, reward metrics and an indication of a set of a plurality of user equipments determined at the distributed unit for τ given time slots, wherein τ is a positive integer, determining an updated set of hyper-parameters at the centralised unit based on the received state vectors, the received reward metrics and received set of the plurality of user equipments and providing, per τ time slots, the updated set of hyper-parameters from the centralised unit to the plurality of distributed units.

The state vector may comprises an indication of at least one of channel state representation, inter-user correlation matrix distance, age of transmission values for the plurality of user equipments and buffer status reports for the plurality of user equipments.

The age of transmission value may define a time period since the last data packet to be transmitted by a UE was generated.

The apparatus may be caused to perform updating the set of hyper-parameters at the distributed unit per time slot.

The apparatus may be caused to perform providing, per τ time slots, the determined state vectors, the determined reward metrics and an indication of the determined set of the plurality of user equipments for τ given time slots to a centralised unit, wherein τ is a positive integer; and receiving, per τ time slots, an updated set of hyper-parameters from the centralised unit, wherein the updated set of hyper-parameters is based on the determined state vectors, the determined reward metrics and determined set of the plurality of co-scheduled user equipments provided to the centralised unit.

Determining the predicted number of spatial layers may comprise a machine learning model which, when executed, is configured to determine the predicted number of spatial layers for the given time slot based on the determined state vector for the plurality of user equipments.

The machine learning model may comprise a neural network.

Determining the set of the plurality of user equipments may comprise a machine learning model which, when executed, is configured to determine the set of user equipments based on the predicted number of spatial layers and the determined state vector.

The machine learning model may comprise a recurrent neural network or a gated recurrent unit.

The machine learning model may comprise a two-stage neural network architecture with a feed forward network determining the spatial stream selection in the first stage followed by a recurrent neural network realised as a custom gated recurrent unit in the second stage determining the set of the plurality of user equipments.

The determined state vector and the determined reward metric may be used as training data for the machine learning model.

Co-scheduling the determined set of the plurality of user equipments may comprise determining a modulation and coding scheme for the determined set of user equipments and requesting the co-scheduled user equipments use the determined modulation and coding scheme.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a schematic diagram of an example multi-cell MU-MIMO network;

FIG. 5 shows a block diagram of uplink MU-MIMO scheduling;

FIG. 6 shows a flowchart of a method according to an example embodiment;

FIG. 7 shows a flowchart of a method according to an example embodiment;

FIG. 8 shows AoT evolution against time for a UE;

FIG. 9 shows a block diagram of an example machine learning model;

FIG. 10a shows a block diagram of an example of a Fully Connected Neural Network;

FIG. 10b shows a block diagram of an example of a Gated Recurrent Unit;

FIG. 11 shows a block diagram of an interaction between a CU and DUs;

FIG. 12 shows a schematic illustration of a RRM entity;

FIG. 13 shows a comparison between UE throughputs of a Naive Round Robin Scheme and a method according to example embodiments for the 5^{th} percentile and the 10^{th} percentile;

FIG. 14 shows a comparison between UE AoTs for a Naïve Round Robin scheme and a method according to example embodiments.

### DETAILED DESCRIPTION

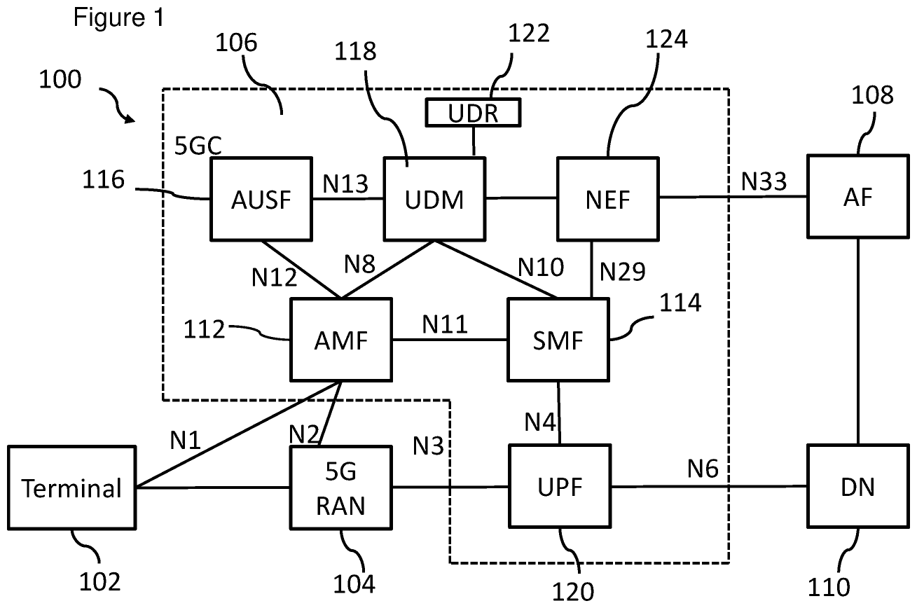

Before explaining in detail the examples, certain general principles of a wireless communication system and mobile communication devices are briefly explained with reference to FIGS. 1 to 3 to assist in understanding the technology underlying the described examples.

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. Quality of Service (QoS) levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more application functions (AF) 108 and one or more data networks (DN) 110.

An example 5G core network (CN) comprises functional entities. The 5GCN 106 may comprise one or more access and mobility management functions (AMF) 112, one or more session management functions (SMF) 114, an authentication server function (AUSF) 116, a unified data management (UDM) 118, one or more user plane functions (UPF) 120, a unified data repository (UDR) 122 and/or a network exposure function (NEF) 124. The UPF is controlled by the SMF (Session Management Function) that receives policies from a PCF (Policy Control Function).

The CN is connected to a UE via the radio access network (RAN). The 5GRAN may comprise one or more gNodeB (GNB) distributed unit functions connected to one or more gNodeB (GNB) centralized unit functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

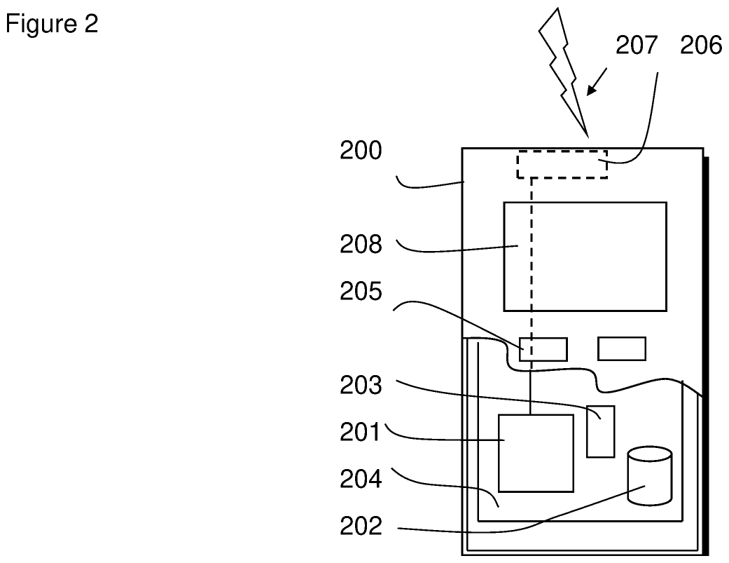

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

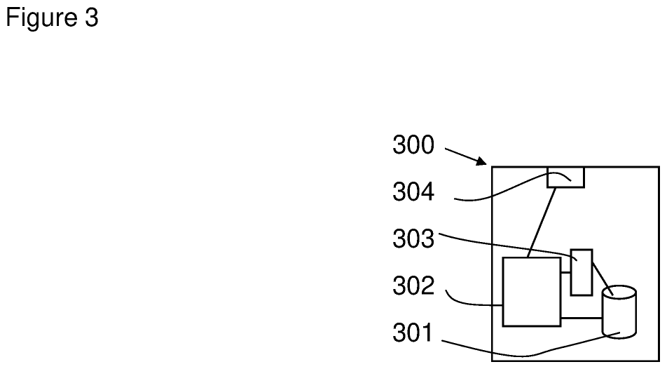

FIG. 3 shows an example of a control apparatus 300 for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

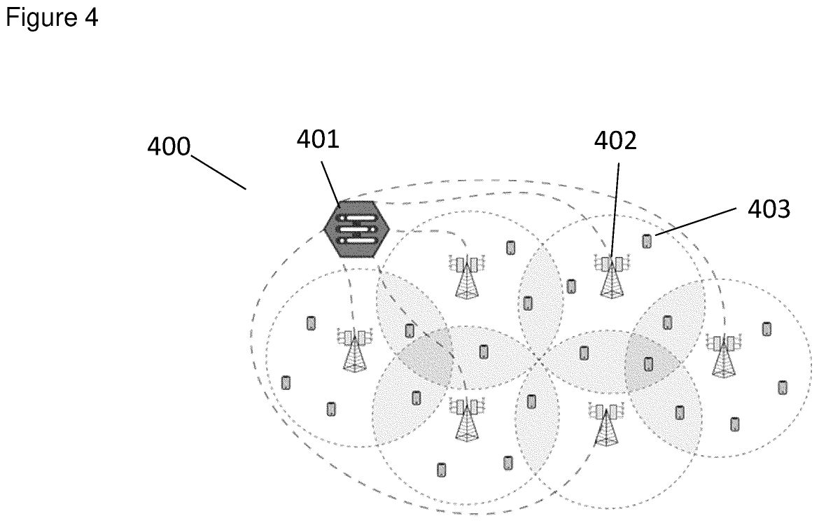

FIG. 4 illustrates a multi-cell Multi-User MIMO (MU-MIMO) network 400 comprising a Centralized Unit (CU) 401, Distributed Units (DU) 402 and UEs 403.

A multi-cell Multi-User MIMO (MU-MIMO) network 400 is a Radio Access Network (RAN) consisting of a set of CUs 401, where each CU 401 is connected to K DUs 402, with the kth DU 402 serving Nₖ UEs 403, k=1, . . . , K. Each DU 402 has N_{D} antennas and the served UEs 403 are equipped with N_{U} antennas each, thus resulting in a MIMO channel with L̅ₖ≤min{N_{D}, N_{U}} independent spatial streams for DU k.

So-called “extreme” MIMO systems are being considered. For example, 6G systems are expected to operate in the 7-20 GHz band, which may enable support for arrays with large numbers of antenna elements and hence, result in MIMO channels with extremely high spatial diversity. For example, it is conceivable to expect antenna arrays with 512-1024 antenna elements in 6G, up from about 192 in 5G at present. The implication of this is that 6G base stations will be able to support more multiplexed (co-scheduled) users both on the uplink (UL) and the downlink (DL). For example, a base station with 256 transceivers (TRX) can be expected to support 16-32 spatial streams on the uplink while a 5G base station with 64 TRX is expected to support less than 16 layers. Assuming that each co-scheduled UE transmits 2-3 spatial streams of data, it is possible to co-schedule around 6-12 UEs on the uplink in 6G, compared to around 2-4 in 5G.

Existing solutions for multi-user MIMO scheduling mostly focus on addressing the DL operations in multi-cell MU-MIMO networks with high spatial diversity. However, the uplink traffic in 6G is expected to be closer in volume to the downlink than is currently the case in 5G.

For example, emerging Augmented Reality (AR) applications for lightweight wearables are increasingly relying on cloud-rendering services. This process requires transmitting coarse video on the UL while capturing the Field of View (FoV) and motion control parameters. This video should be delivered without delay to a render farm, which, in response, returns renderings of 3D objects that the user device overlays on a display. The latency requirements of this service are significant, and require wireless solutions with large bandwidths, minuscule uplink delays and large capacity to support a vast number of users.

Further, the introduction of new Application Data Unit (ADU) metrics, in addition to existing Key Performance Indicators (KPIs) and Key Value Indicators (KVIs) in 6G systems, may impose additional constraints on networks. 6G networks may include KPIs and KVIs which take application awareness into account for the decisions made by Radio Resource Management (RRM) entities. For example, 6G may guarantee the correct reception of information bits and also gauge the relevance of the transmitted information by factoring in application-specific functionality.

Age of Transmission (AoT), defined as the time elapsed since the last data packet to be transmitted by a UE was generated, is one such KPI which measures the timeliness of information at the UEs. Additionally, AoT also encapsulates the Packet Delay Budget (PDB), which makes it an attractive KPI for future 6G networks.

The following relates to multi-user MIMO scheduling on the uplink, for example for 6G although it may also be applied to any other suitable communication system, such as 5G.

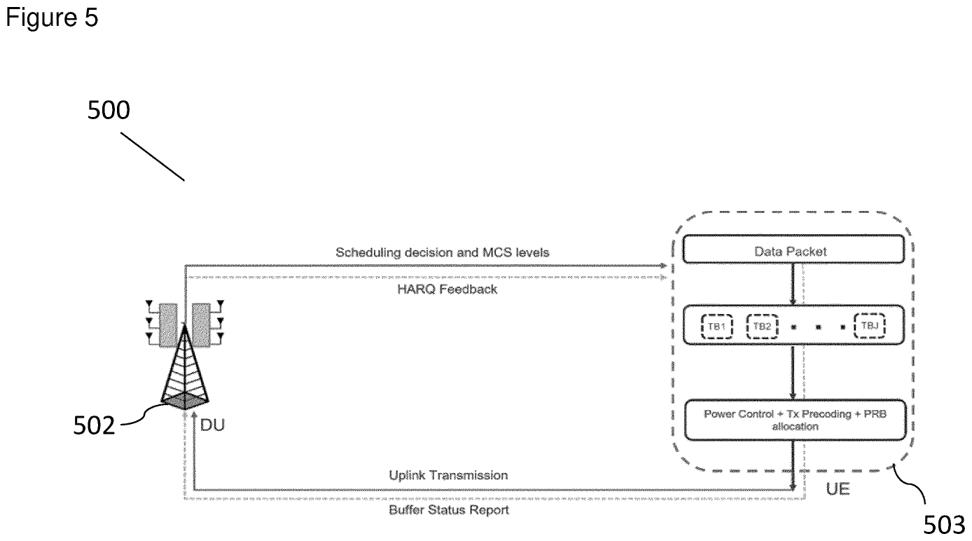

It is possible to co-schedule multiple users for UL transmission where there is a large number of transceivers (TRX) at the DU. FIG. 5 illustrates an example UL MU-MIMO scheduling process 500, where the DU 502 and the UEs 503 in the cell communicate in a slotted time framework and the UEs 503 always have an application data unit (ADU) to transmit.

At the beginning of a timeslot t, all UEs 503 send a Buffer Status Report (BSR) to the DU 502 indicating the number of bits pending transmission in their UL buffers.

Depending on the cell load and spatial diversity, the DU 502 must then allocate a number of active spatial streams to each UE 503 and indicate the scheduling decision to the set of co-scheduled UEs 503, along with their corresponding MCS levels for UL transmission.

The co-scheduled UEs 503 then transmit their Transport Blocks (TBs), whose bitsize is proportional to their assigned Modulation and Coding Scheme (MCS). They then send an updated BSR based on the HARQ ACK/NACK received at the end of the timeslot t.

UE co-scheduling, spatial stream selection, and MCS selection for each UE 503 are the key decisions needed to steer the performance of an UL MU-MIMO system. These decisions are controlled by the scheduler, where traditional scheduling methods include, for example, Round Robin (RR) and Proportional Fairness (PF). In the past, these techniques have sufficed to address the traditional KPIs of throughput and latency for single user transmission. However, for high dimensional MIMO channel, such as that expected in 6G, combined with extremely dynamic environments in higher frequencies as well as new KVIs such as energy-efficiency, may make the job of traditional schedulers more challenging.

To illustrate with an example, suppose that there are 20 users to be served by a DU 502. The DU 502 must decide which among the 20 users to co-schedule for transmission in a particular UL slot. If the DU 502 schedules too many users, the intra-cell inter-user interference (caused by the users jointly transmitting their respective data on the same resources) may adversely affect the overall bit-rate for each user. If the DU 502 schedules too few users, it is leaving out usable resources which may lead to less system efficiency. Furthermore, if the DU 502 chooses the wrong combination of co-scheduled users, the chosen users may adversely impact each other's bit-rates. Such problems do not exist in single-user MIMO systems, but may become bottlenecks in extreme MU-MIMO networks.

To summarise, the challenge involved in MU-MIMO scheduling on the UL may be considered as choosing the right subset of co-scheduled users such that the following targets are satisfied.

The number of co-scheduled users and the sum total of all their spatial streams (or layers) is less than or equal to a predefined number. For example, if the gNB has 64 TRX, the sum total of all the transmitting layers from all the users needs to be less than or equal to 64 in theory. There may also a product-specific constraint on the number of transmitting layers on the UL.

So, the user selection should be such that the total number of all their spatial streams is within this limit.

The overall AoT for all (or most) users is acceptable. This is important for satisfying latency requirements for delay sensitive applications, such as AR, alarms and or bio-comms.

The overall system throughput should be maximized subject to the first two targets

The three targets above should be achieved with practically feasible techniques. This is important because choosing a subset of users to co-schedule from a larger set of served users depends on how much overall bit-rate is achieved for each user when they are co-scheduled together. This is a combinatorial problem which is known to be NP-hard (non-polynomial time complexity in the number of served users). As an example, suppose that there are 10 UEs to be served with the total maximum number of spatial layers that the gNB can support being 16. Then, selecting k UEs can be done in

$$( \begin{matrix}10 \\ k\end{matrix} )$$

ways, where the notation

$$( \begin{matrix}n \\ k\end{matrix} )$$

denotes “n choose k”. The total number of ways of choosing a subset of co-scheduled users

$${\sum }_{k = 1}^{10} ( \begin{matrix}10 \\ k\end{matrix} ) = 1 23.$$

Further, for each chosen combination, we need to jointly compute the MCS levels and it is quite evident why this action space is unmanageable by naïve approaches.

Co-scheduling users (i.e., scheduling users at the same time) may be viewed as a dynamic resource allocation problem, which can be combined with throughput optimization to form a Dynamic Constrained Resource Optimization (DCRO) problem. Constrained optimization frameworks introduce new hyper-parameters which directly affect the overall system performance. Furthermore, as the network size grows, it may become computationally challenging to tackle the constraints imposed by all the UEs at the DU alone.

Throughput maximization in a MU-MIMO scenario is restricted by antenna correlation and inter-user interference, which is why current 5G MU-MIMO products are limited to low order implementations (e.g., up to 4 co-scheduled layers in the same resources due to lack of spatial separation). The achievable gains may thus be limited.

A DDPG based heuristic algorithm has been suggested to jointly solve the precoding matrix selection and UE scheduling for throughput maximization in a MU-MIMO UL scenario. The setting considered a single cell, and fully disregarded AoT considerations. It is not clear if this method can be applied to a multi-cell setting (where there is inter-cell interference in addition to intra-cell interference) with near-optimal results.

Minimising the network-wide Average AoT (AAoT) with delay constraints in uplink MU-MIMO scenario for short packet IoT network has been addressed. An AAoT-optimal algorithm based on the Whittle's index and complete subgraph detection has been proposed to jointly tackle UE scheduling and inter-user interference. This approach considers single-antenna users and does not target the overall system throughput.

A max-weight-based scheduling algorithm for single antenna DL systems has been proposed. Since this proposal is targeted for DL transmissions, it does not naturally extend to UL.

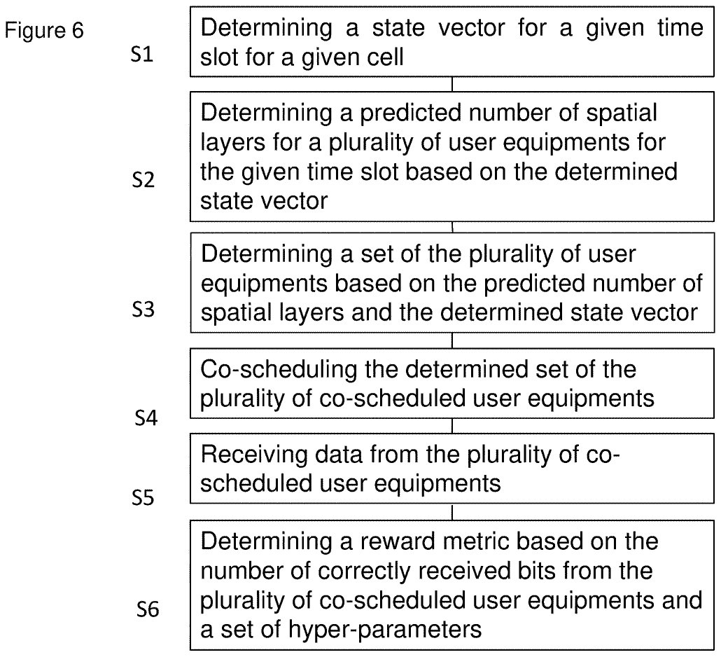

FIG. 6 shows a flowchart according to an example embodiment. The method may be performed at a DU. The DU may be part of a MU-MIMO system (for example as described with reference to FIG. 4).

In S1, the method comprises determining a state vector for a given time slot for a given cell.

In S2, the method comprises determining a predicted number of spatial layers for a plurality of user equipments for the given time slot based on the determined state vector.

In S3, the method comprises determining a set of the plurality of user equipments based on the predicted number of spatial layers and the determined state vector.

In S4, the method comprises co-scheduling the determined set of the plurality of user equipments.

In S5, the method comprises receiving data from the plurality of co-scheduled user equipments.

In S6, the method comprises determining a reward metric based on the number of correctly received bits from the plurality of co-scheduled user equipments and a set of hyper-parameters.

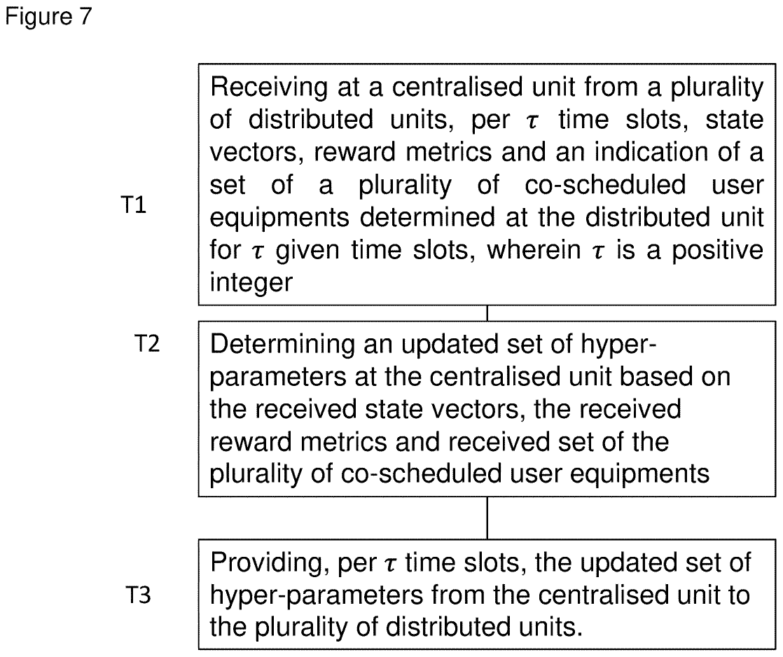

FIG. 7 shows a flowchart of a method according to an example embodiment. The method may be performed at a CU. The CU may be part of a MU-MIMO system (for example as described with reference to FIG. 4).

In T1, the method comprises receiving at a centralised unit from a plurality of distributed units, per τ time slots, state vectors, reward metrics and an indication of set of a plurality of user equipments determined at the distributed unit for τ given time slots, wherein τ is a positive integer.

In T2, the method comprises determining an updated set of hyper-parameters at the centralised unit based on the received state vectors, the received reward metrics and received set of the plurality of user equipments.

In T3, the method comprises providing, per τ time slots, the updated set of hyper-parameters from the centralised unit to the plurality of distributed units.

The state vector may comprise an indication of at least one of channel state representation, inter-user correlation matrix distance, age of transmission value for each of the plurality of user equipments and buffer status reports for each of the plurality of user equipments.

The age of transmission (AoT) value defines a time period since the last data packet to be transmitted by a UE was generated.

The following definitions, notation and system model may be used to define the state vector.

Served UEs are the UEs to be served by a DU that compete for resource allocation.

Co-scheduled UEs in a particular time slot are the UEs that are assigned the same set of time-frequency resources to transmit their respective data to a serving DU in that time slot. u_{n,k} denotes the n^{th} UE in Cell k. Each UE has N_{U} transmit antennas and L_{n,k}(t)≤N_{U} spatial streams of data in the time slot t. Each DU has N_{D} receive antennas. There is an upper limit of L̅ₖ≤N_{D} on the total number of spatial layers from all the co-scheduled UEs to DU k.

The effective uplink channel between a UE u_{n,k} and DU k on resource element (RE) m in time slot t is H_{n,k}(m, t)∈ [symbol] ^{N}^{_{D}}^{×L}_{n,k}^{(t)}.

The overall set of served UEs by DU k is [symbol] ₖ, and there are Nₖ UEs in this set.

The set of co-scheduled UEs for DU k in time slot t is

$${𝒰}_{k}^{′} ( t ) ⊆ {𝒰}_{k} .$$

So, this means that

$${\sum }_{{u}_{n , k} ∈ {𝒰}_{k}^{′} ( t )} \leq {\overline{L}}_{k} .$$

The total number of spatial layers from all the co-scheduled UEs in cell k is

$${L}_{k} ( t ) = {\sum }_{{u}_{n , k} ∈ {𝒰}_{k}^{′} ( t )} {L}_{n , k} ( t ) .$$

The data vector of UE u_{n,k} that is transmitted on RE m in time slot t is denoted by x_{n,k}(m, t)∈ [symbol] ^{L}_{n,k}^{(t)×}1.

The received signal vector, of size N_{D}×1, at DU k on resource element (RE) m in time slot t is given by:

$${y}_{k} ( m , t ) = {\sum }_{{u}_{n , k} ∈ {𝒰}_{k}^{′} ( t )} {H}_{n , k} ( m , t ) {x}_{n , k} ( m , t ) + {n}_{k} ( m , t ) \qquad ( 1 )$$

where

$${n}_{k} ( m , t ) {=}^{def} {\sum }_{l \neq k} {\sum }_{{u}_{n , l} ∈ {𝒰}_{l}^{′} ( t )} {H}_{n , l} ( m , t ) {x}_{n , l} ( m , t ) + w ( m , t )$$

is the instantaneous inter-cell interference-plus-thermal noise (I+N) with covariance matrix Rₖ(m, t)∈ [symbol] ^{N}^{_{D}}^{×N}^{_{D}}, and w(m, t)∈ [symbol] ^{N}^{_{D}}^{×1} is the thermal noise vector which is assumed to additive white Gaussian.

The post-equalization SINR (with an LMMSE detector) γ_{n,k}(m, t) for UE u_{n,k} at t is a function of

$${H}_{n , k} ( m , t ) , {R}_{k} ( m , t ) , and {H}_{{n}^{′} , k} ( m , t ) , ∀ {u}_{{n}^{′} , k} ∈ {𝒰}_{k}^{′} ( t ) ∖ \{ {u}_{n , k} \}$$

(i.e., excluding u_{n,k})

The effective throughput Q_{n,k}(t) for UE u_{n,k} at t is a function of {γ_{n,k}(m, t)} over all REs.

β_{n,k}(t)=1 if UE u_{n,k} is scheduled at time t, and 0 otherwise.

$${β}_{k} ( t ) {=}^{def} [ {β}_{1 , k} ( t ) , … , {β}_{{N}_{k} , k} ( t ) ] .$$

β_{n,k}(t) denotes the BSR of UE u_{n,k} at time t, which indicates the number of bits in the current packet that have not yet been correctly received at DU k. β_{n,k}(t+1)>β_{n,k}(t) if and only if a new packet is generated, either due to the previous packet being completely received successfully or due to packet failure even after the maximum number of HARQ retransmissions.

The model under consideration can be viewed as a Markov Decision Process (MDP). The state of the unconstrained MDP is a tuple comprising of several variables that influence the resulting policy. We assume that there are M REs in total, and we denote by Hₖ(t)∈ [symbol] ^{N}^{ₖ}^{×M×N}^{_{D}}^{×N}^{_{U}} the tensors containing the channel transfer matrices of all the UEs in the cell, where Hₖ(n, m, t)∈ [symbol] ^{N}^{_{D}}^{×N}^{_{U}} denotes the (n, m)^{th} slice of the tensor Hₖ(t), which represents the channel matrix between the n^{th} UE (i.e., UE u_{n,k}) and DU k on RE m. This can be estimated in practice using sounding reference signals (SRS) and interpolation. Similarly, we denote by Rₖ(t)∈ [symbol] ^{M×N}^{_{D}}^{×N}^{_{U}} the tensor containing the covariance matrices of the instantaneous interference-plus-noise, with the m^{th} slice being Rₖ(m, t)∈ [symbol] ^{N}^{_{D}}^{×N}^{_{U}}. This is impossible to estimate in practice in any causal system, and we can only have an approximation using a long-term I+N covariance matrix that is estimated from past transmissions. Then, the observation tensor, denoted by

$${H}_{k}^{′}$$

(t)∈ [symbol] ^{N}^{ₖ}^{×M×N}^{_{D}}^{×N}^{_{U}}, is obtained as a tensor with the (n, m)^{th} slice

$${H}_{k}^{′}$$

(n, m, t)∈ [symbol] ^{N}^{ₖ}^{×M×N}^{_{D}}^{×N}^{_{U}} being

$${R}_{k}^{- 1 / 2}$$

(m, t) Hₖ(n, m, t). This is called the noise-whitened channel matrix. The large antenna arrays in 6G MIMO systems result in extremely high-dimensional observation tensors which impede the design of computationally inexpensive policies. Thus, it is necessary to obtain low-dimensional representations of the channel state information and interference statistics to use them as state variables so that we can compute tractable policies.

An example vector for state representation proposed is as follows:

The channel tensor is represented by hₖ(t), a Nₖ×1 vector, which is obtained by taking the average of square of the absolute value of every element of

$${H}_{k}^{′} ( t )$$

in the last three dimensions. To be precise, the n^{th} value of hₖ(t) is given by

$$\frac{1}{M {N}_{D} {N}_{U}} {\sum }_{m} {‖ {H}_{k}^{′} ( n , m , t ) ‖}^{2} .$$

The interference information is represented by Dₖ(t), an Nₖ×Nₖ symmetric, real-valued matrix, with the entries of Dₖ(t) denoting the correlation matrix distance between users. To be precise, the (n, n′)^{th} entry of Dₖ(t) is given by

$$1 - \frac{t r \{ {K}_{n , k} ( t ) {K}_{{n}^{′} , k} ( t ) \}}{{‖ {K}_{n} , k ( t ) ‖}_{F} {‖ {K}_{{n}^{′} , k} ( t ) ‖}_{p}} ∈ [ 0 , 1 ] ,$$

where K_{n,k}(t)∈ [symbol] ^{N}^{_{D}}^{×N}^{_{U}} denotes the noise-whitened channel correlation of UE u_{n,k} and can be calculated as

$${K}_{n , k} ( t ) = \frac{1}{M} {\sum }_{m} {H}_{k}^{′} ( n , m , t ) {{H}_{k}^{′} ( n , m , t )}^{H} .$$

In the expression above, tr{X} denotes the trace of a matrix X and ∥X∥_{F} denotes its Frobenius norm. Since Dₖ(t) is a symmetric matrix, only its upper triangular elements are necessary. So, we form the observation variable dₖ(t) with Nₖ(Nₖ+1)/2 elements.

Additionally, the state tuple may consist of two more variables. The vector of AoT values denoted by eₖ(t) and the vector of BSR values denoted by bₖ(t).

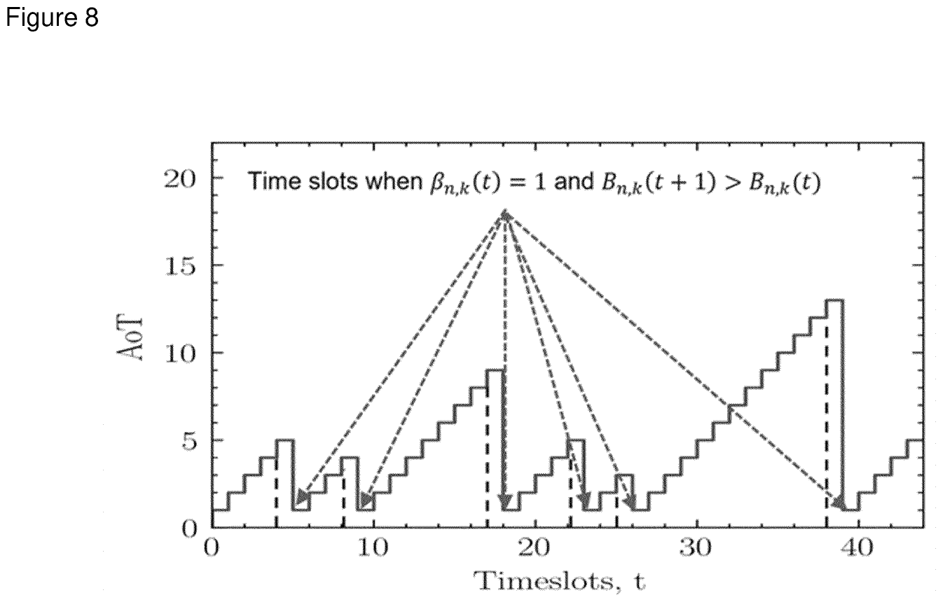

Both of these variables influence the policy and the hyper-parameters. Based on the BSR values shared by the UEs, the AoT value A_{n,k}(t) of a UE u_{n,k} is updated as follows (see FIG. 8):

$${A}_{n , k} ( t + 1 ) = {A}_{n , k} ( t ) ( 1 - {Λ}_{n , k} ( t ) ) + 1$$

where, Λ_{n,k}(t)=1 if β_{n,k}(t)=1 and β_{n,k}(t+1)>β_{n,k}(t), and 0 otherwise. FIG. 8 illustrates the evolution of AoT of UE u_{n,k} over the time-horizon, where the AoT value evolves as a step-function and is reset to its default value when the ADU is successfully received at the DU.

The MU-MIMO scheduling state sₖ(t) at timeslot t is defined as sₖ(t) [symbol] (hₖ(t), dₖ(t), eₖ(t), bₖ(t)). Where hₖ(t) is a channel state representation, dₖ(t) is the inter-user correlation matrix distance, eₖ(t) is the user AoT and bₖ(t) is the user buffer status report.

This state variable has

$$\frac{{N}_{k} ( 7 {N}_{k} + 1 )}{2}$$

elements, which is of order

$$𝒪 ( {N}_{k}^{2} )$$

and solely depends on the number of UEs to be served by the DU.

Co-scheduling the determined set of the plurality of co-scheduled user equipment may comprise determining a modulation and coding scheme for the determined set of user equipments and requesting the co-scheduled user equipments use the determined modulation and coding scheme.

In an example embodiment, in each time slot and in each cell, a DU forms a state vector which contains a representation of the noise-whitened channel gains of all the UEs, the correlation matrix distance between all pairs of UEs (or any such similar metric), the AoT information of all the UEs, and the BSR of all the UEs.

The DU then uses the state vector to predict the maximum total number of spatial layers to be served from all co-scheduled UEs in the current time slot, for example using a neural network (NN) with trainable parameters.

The DU then uses the predicted number of spatial layers and the state vector to determine the set of co-scheduled UEs in the current time slot, for example using a recurrent neural network (RNN) (or any similar sequential machine-learning model like gated recurrent unit (GRU)) with trainable parameters.

The DU then jointly estimates the MCS of the chosen set of co-scheduled users.

The DU then co-schedules the chosen set of UEs, requesting them to use the predicted MCS levels for their data transmission.

The DU then calculates a reward metric upon receiving the transmitted data of those co-scheduled UEs, where the reward metric is a function of the number of correctly received bits of all the UEs and a set of hyper-parameters.

The DU then determines the next state vector.

The means for determining the predicted number of spatial layers may comprises a machine learning model which, when executed, is configured to determine the predicted number of spatial layers for the given time slot based on the determined state vector for the plurality of user equipments. The machine learning model may comprise a neural network.

The means for determining the set of user equipments may comprise a machine learning model which, when executed, is configured to determine the set of user equipment based on the predicted number of spatial layers and the determined state vector. The machine learning model may comprise a recurrent neural network or a gated recurrent unit.

The machine learning model may comprise a two-stage neural network architecture with a feed forward network configured to determine the spatial stream selection in the first stage followed by a recurrent neural network realised as a custom gated recurrent unit in the second stage determining the plurality of user equipments. Such a two-stage architecture may be referred to as a multi-stage actor network.

An Actor Network architecture may be used to obtain an approximate stochastic policy. Since the action space is multi-dimensional in nature, a multi-stage actor network is used to efficiently capture the inter-dependencies of the actions. It must be noted that the decision of MCS selection μₖ(t) solely depends on the co-scheduled UEs. Thus, the policy is designed to jointly compute the decision parameters Lₖ(t) and βₖ(t) using the parameterized policy. Then, an estimate of the MCS levels \hat{μ}ₖ(t) is obtained deterministically based on the set of co-scheduled UEs. Let aₖ(t) [symbol] (Lₖ(t), βₖ(t)) denote the vector of joint actions for each UE served by DU k. Following the chain rule of probability, the parametrized stochastic policy w.r.t Lₖ(t) and βₖ(t) can be represented as follows:

$$π ( {a}_{k} ( t ) \vert s ( t ) ; θ ( t ) ) {=}^{def} P ( {L}_{k} ( t ) \vert {s}_{k} ( t ) ; {θ}_{k} ( t ) ) P ( {β}_{k} ( t ) \vert {L}_{k} ( t ) , {s}_{k} ( t ) ; {θ}_{k} ( t ) )$$

where, θₖ(t) represents the vector of trainable variables (at time t) of the actor network i.e.,

$${θ}_{k} ( t ) = [ {θ}_{{L}_{k}} ( t ) , {θ}_{{β}_{k} ( t )} ] .$$

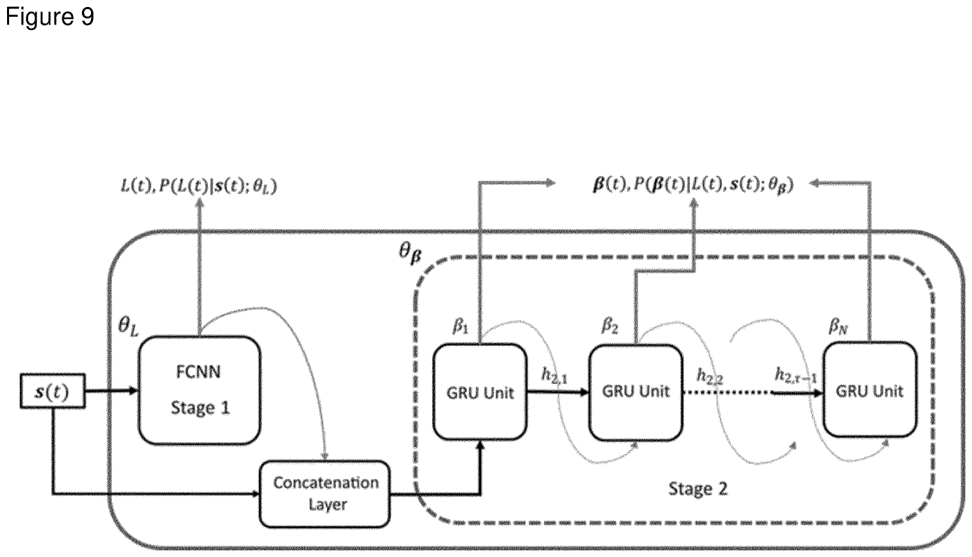

From here on, we drop the DU index k for brevity unless required. FIG. 9 illustrates a multi-stage actor network, where L(t) and the corresponding probability value are obtained at stage 1 and the set of co-scheduled UEs along with the probability values are obtained at stage 2.

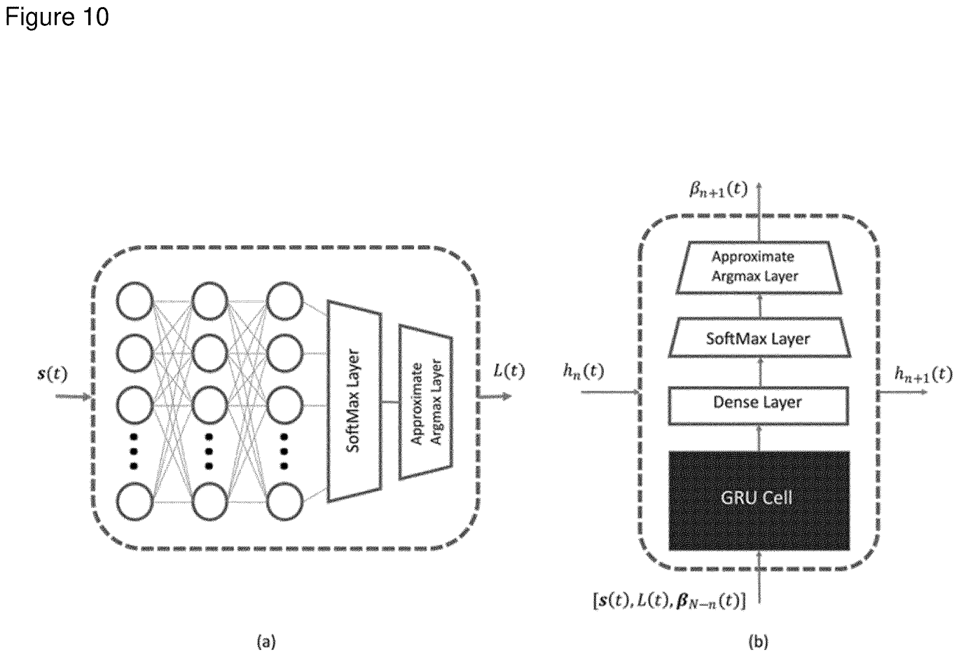

Stage 1 is realized by a Fully Connected Neural Network (FCNN) as depicted in FIG. 10a and comprises of three dense layers followed by a softmax layer and a differentiable layer approximating the argmax functionality to select the most probable L(t) value. The output of stage 1 and the MDP state are concatenated before passing it on to stage 2 for training stability reasons.

Stage 2 is comprised of a GRU unit at its core. Unlike conventional RNN implementations, a GRU is run inside a for-loop to sequentially select the co-scheduled UEs at time slot t. Such a sequential architecture greatly reduces the computational complexity with respect to the combinatorial action space in βₖ. The number of iterations in the for-loop N̅(t), is decided based on L(t) obtained as the output of FCNN and is given by N̅(t)=L(t)/L̅_{U}(t), where L̅_{U}(t) is the average number of spatial streams supported by the UEs in the cell.

FIG. 10b depicts the internal working of stage 2. For each iteration n in stage 2, the GRU Unit takes a hidden state and a compound input obtained by concatenating s(t), L(t) from stage 1 and β_{N-n}(t), the vector of UEs selected until the current iteration. The output of the GRU Cell inside the GRU Unit is then fed to a dense projection layer followed by SoftMax layer and a differentiable argmax layer to select the most probable UE at each iteration n.

The determined state vector and the determined reward metric may be used as training data for the machine learning model. For example, the trainable parameters of the NN and RNN in each DU may learnt on the fly using reinforcement learning, wherein the parameters are trained using the current state vector, the reward metric, and the next state vector.

The method may comprise updating the set of hyper-parameters at the distributed unit per time slot.

The method may comprise providing, per τ time slots, the determined state vectors, the determined reward metrics and an indication of the determined set of the plurality of user equipments for τ given time slots to a centralised unit, wherein τ is a positive integer and receiving, per τ time slots, an updated set of hyper-parameters from the centralised unit, wherein the updated set of hyper-parameters is based on the determined state vectors, the determined reward metrics and determined set of the plurality of user equipment provided to the centralised unit.

In other words, the hyper-parameter learning functionality is split between the DUs and the CU, wherein each DU may locally update the hyper-parameters in each time slot and each DU sends the state vectors, the actions, and the reward metric to the CU every time slots, where τ is a network operator chosen number. The CU then performs a global update of the hyper-parameters and sends them to all the DUs every τ time slots.

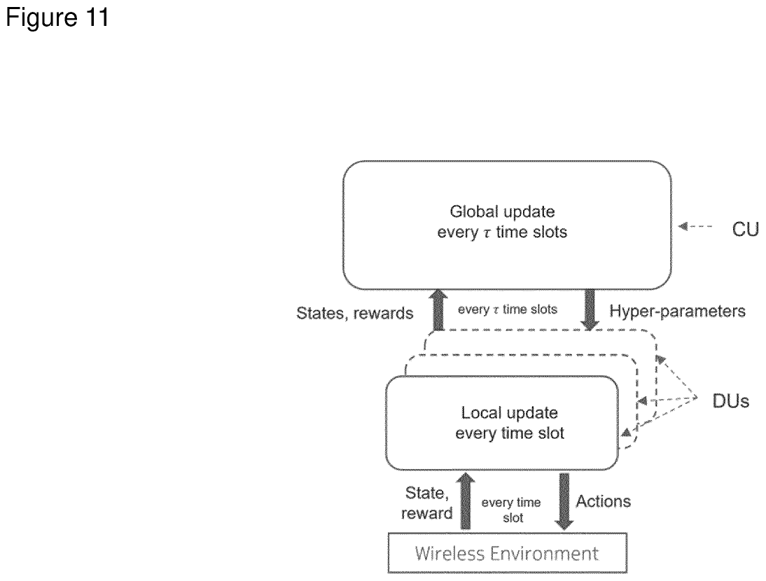

FIG. 11 illustrates a schematic diagram of an example system. The DU performs an action (co-scheduling the determined UEs) and determines a state vector and a reward every time slot. The DU performs a local update of the hyper-parameters every time slot. The determined state vectors and rewards fort time slots are provided to the CU which performs a global updated every τ time slots and provides the updated hyper-parameters to the DU.

The joint decision-making performed by the separate CU and DU nodes may be considered as a single Artificial Intelligence (AI) scheduler.

The training procedure may be split into two parts, a primal update and a dual update.

Primal update refers to the procedures that learn the training parameters of the actor and the reward critic networks. Like DDPG and Soft Actor-Critic (SAC) techniques, the method may employ two sets of actor and critic networks, termed primary and target networks, to introduce stability in training. In such an approach, the parameters of the primary actor and critic network are updated using the subgradient method, while the weights of the target network are updated as a convex combination of the primary network weights and the previous target network weights.

Dual update refers to the computation of the hyper-parameters (Lagrange Multipliers). This method splits the dual update across the CU and DUs (see FIG. 11) where the dual, or global, update at the CU is performed only at multiples of τ, a parameter defined by the network operator. One technical advantage of such a functional split is stability with respect to the hyper-parameters, thereby inducing stability in the parameterized stochastic policy. It can be noted that the local dual update is performed using a linear cost function, whereas the remote dual update is performed with respect to a non-linear Q-value, Q_{c}. Although, both linear and non-linear dual updates consider historical data in performing the dual cost, the non-linear approach captures the global phenomenon by fusing the actions of other DUs stored at the global RB. It can be observed that the remote dual update borrows design principles from the MADDPG technique used for multi-agent scenarios. Contrary to the original MADDPG method, we propose to update the reward critic locally at the DU, while the cost critic is updated either at the CU or DU. This is because the LM influences the reward critic and thus the global CU level information is already taken into consideration with the remote dual update in the cost critic.

The method may provide a way to jointly handle multiple actions while solving the unconstrained dynamic resource allocation problem.

The method may optimise timely throughput in a multi-cell MU-MIMO system, through a split of scheduling responsibilities across the RAN elements in an UL multi-cell MU-MIMO system. Timely throughput here refers to the throughput achieved by solving a DCRO problem subject to AoT constraints at the UEs.

Since the CU is equipped with more resources, the scheduling functionality is split across the CU and DUs to achieve a trade-off between throughput and the AoT metric, while also ensuring stability in terms of hyper-parameters.

The scheduling functionality with functional split across CU and DU for alternatively optimizing the decision parameters and the hyper-parameters is an efficient way of implementing the NN parameter-optimization in real time. In the real world, this is expected to translate to better UE throughputs while respecting the latency requirements.

The policy network (i.e., the scheduling policy implementation) captures multi-dimensional action spaces in a scalable manner (with respect to the number of UEs to be served by the DU). In the real world, this means that the proposed solution will possibly require less memory and computational resources than other known machine-learning-based algorithms for the same task.

By leveraging scheduling experience (simulated and in the real world), the performance of the proposed solution will improve over time through mere usage. In other words, enhanced scheduling performance will be delivered to users and customers at a fraction of current costs.

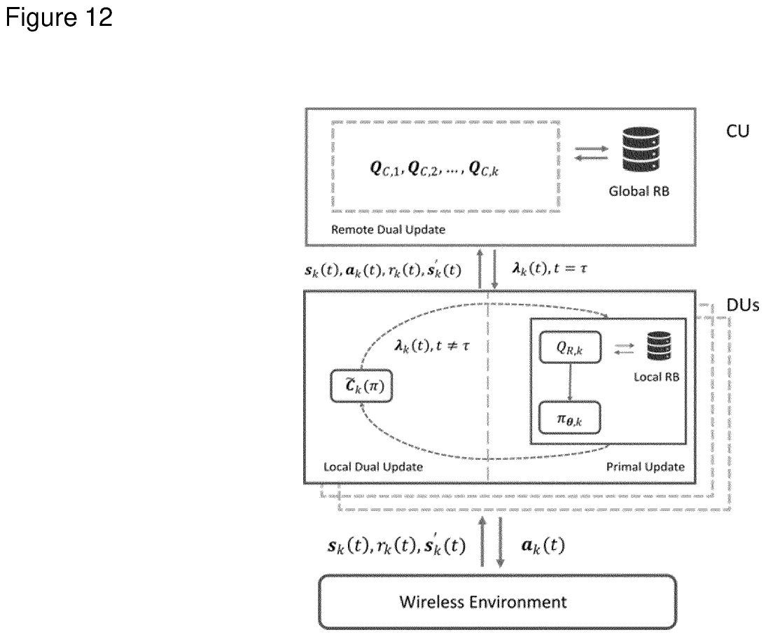

FIG. 12 illustrates an example dataflow between CU and DU that a 6G RAN implementing the method may conduct. This data is important to support inference runs at the trained policy network and is as follows.

In this example dataflow, the observations gathered from the wireless environment are encapsulated in the form of a low-dimensional state representation sₖ(t) at each DU k. This state variable contains

$$\frac{{N}_{k} ( 7 {N}_{k} + 1 )}{2}$$

elements where Nₖ IS the total number of users to be served by DU k.

The parametrized stochastic policy π_{θ,k} performs a forward pass w.r.t. sₖ(t) and λ(t) to obtain the multi-dimensional action vector aₖ(t).

The UEs scheduled for transmission send their TBs corresponding to the MCS value indicated by their respective DUs.

The DUs compute the immediate reward, observe the next state

$${s}_{k}^{′} ( t )$$

and store the state-action-reward tuple

$$( {s}_{k} ( t ) , {a}_{k} ( t ) , r ( t ) , {s}_{k}^{′} ( t ) )$$

in the local Replay Buffer (RB). Every τ time slots, each DU k sends the state-action-reward tuple to the CU to be stored at the global RB. The size of this tuple of real-valued numbers is Nₖ(7Nₖ+2)+2. Therefore, the total number of real-valued numbers moved to the CU every τ timeslots is K(Nₖ(7Nₖ+2)+2). This transmission of data from DU to CU is the single heaviest load exchange. In practical embodiments, τ can take values close to 10, thus yielding manageable traffic loads.

Exchanging the state-action-reward tuples between CU and DU may be based on a proprietary implementation or a standardized exchange protocol, which may ease cross-vendor compatibility. In 5G, communication on the CU-DU interface is based on the F1 Application Protocol (F1AP), which is specified within 3GPP standards. Enhancing standards with support for ML procedures such as that of FIGS. 9 to 10 may be advantageous.

The reward function plays an important role in the training procedures and in assisting the policy to quickly adapt to dynamic environments. An immediate reward function may be defined which captures the entirety of the problem succinctly. Since optimizing for timely throughput pertains to solving a DCRO problem, concepts from the constrained MDP (CMDP) framework can be utilized to define the immediate reward function that captures both throughput and AoT. An important aspect of this approach is that the CMDP framework introduces Lagrange multipliers (LM), which can be modelled as hyper-parameters and updated on the fly, leading to automation in the design. The Lagrange function of the CMDP is given by:

$$L ( π , λ ) = R ( π ) - {λ}^{T} C ( π )$$

where, the vector λ comprises the LM associated with each UE in a cell; R(π) is the long-term reward, which corresponds to the throughput given as,

$$R ( π ) := {\sum }_{t = 0}^{∞} {\sum }_{n}^{{N}_{k}} U ( {\hat{Q}}_{n} ( t ) ) ,$$

where U(\hat{Q}ₙ(t)) is the utility of effective throughput of the UEs in the cell and U(·) refers to the alpha-fairness function to ensure fairness among UEs. Similarly, C(π) denotes the vector of long-term cost incurred by considering the AoT constraints. To ensure that the AoT constraints capture both the timeliness of information and adhere to PDB, Cₙ(π) is taken to be the average peak AoT (APAoT). APAoT is the average of the peaks just before the AoT value resets to its default value and is formally defined as,

$${C}_{n} ( π ) := \frac{{\sum }_{t = 0}^{∞} {A}_{n} ( t ) {Λ}_{n} ( t )}{{\sum }_{t = 0}^{∞} {Λ}_{n} ( t )} .$$

The immediate reward function can thus be defined as:

$$r ( t ) = r ( a ( t ) , β ( t ) ; λ ( t ) ) := {\sum }_{n}^{{N}_{k}} U ( {\hat{Q}}_{n} ( t ) ) - {λ}^{T} ( e ( t ) - \overline{A} ) ,$$

where Ā is the AoT threshold.

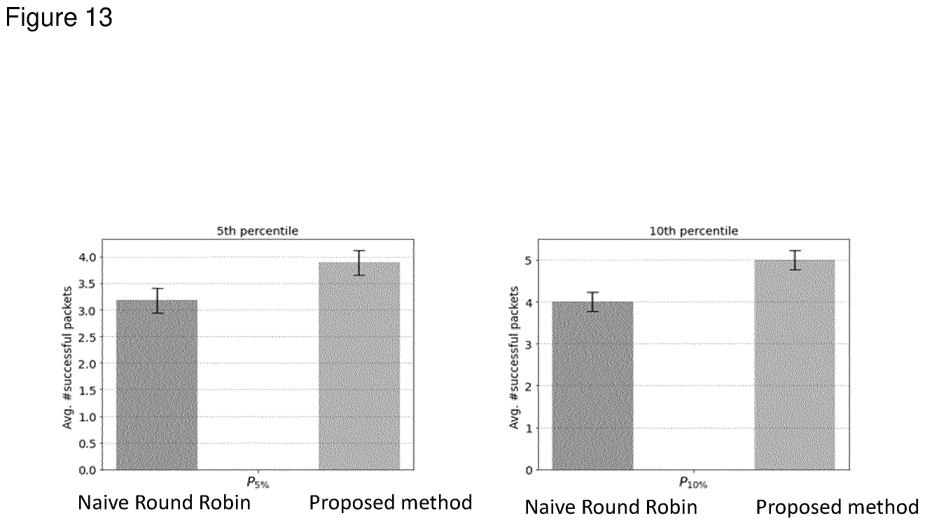

The results of a relatively small-scale multi-cell, multi-link-level simulation (MCMLLS) are shown in FIG. 13. A 64-TRX MIMO receiver is considered. This is not an extreme MIMO system but considered here just to verify that the proposed method works as expected. The simulation code was written in Python and TensorFlow, and we consider a 3-cell, 30-UE setting with the parameters shown in Tables 1 to 5.

TABLE 1
Site Parameters

| | |
|---|---|
| # sites | 1 |
| # cells/site | 3 |
| ISD | 200 m |
| # users | 30 |

TABLE 2
Channel Parameters

| Channel Model | 38.901 Urban Micro | |
|---|---|---|
| f_{c} | 3.5 | GHz |
| Subcarrier-spacing | 30 | kHz |
| # PRBs | 24 | |
| Channel BW | 8.64 | MHz |

TABLE 3
Other Parameters

| Target received power P₀ | −100 | dBm |
|---|---|---|
| Open loop power control fractional path-loss | 0.85 | |
| compensation factor α | | |
| Maximum total output power per UE | 23 | dBm |
| Noise figure at cell | 0 | dB |
| Number of independent user drops | 5 | |
| Number of slots per drop | 500 | |
| BW allocation to UE | Variable according | |
| | to Tx power limit | |
| HARQ max number of retransmissions | 4 | |
| Slot duration | 0.5 | ms |

| | |
|---|---|
| Channel estimation | Perfect CSI |
| Interference + noise covariance estimation | Perfect |
| LDPC codes | 5G |

TABLE 4
Antenna parameters

| | |
|---|---|
| Cell antenna array | 64-TRX (4 × 8 × 2) |
| # Antenna elements | 192 (3 × 1 subarray) |
| UE antenna array | 4-TRX (1 × 2 × 2) |

TABLE 5
Site antenna configuration

| | |
|---|---|
| Mechanical bearing | [0°, 120°, −120°] |
| Mechanical down tilt | 0° |
| Slant angle | 0° |
| Electrical panning | 0° |
| Electrical uptilt | −7.5° |
| HPBW in the azimuth | 95° |
| HPBW in the elevation | 95° |
| Subarray size | 3 × 1 (row × col) |
| AE row spacing | 0.65λ |
| AE column spacing | 0.5λ |
| Maximum sub-array gain | 9.5 dBi |
| Slant angles (degrees) in the panel | [45°, −45°] |
| in the local coordinate system | |

This is a small network set-up and the intention is to show that the proposed method works. Since there is no MU-MIMO scheduling baseline on the uplink, we assume round robin (RR) scheduling as a baseline, where in each slot, users are scheduled in a RR fashion subject to the total number of spatial layers being limited to 16. We call this “naïve round robin” scheduling. The packet length is taken to be 100,000 bits.

For the proposed method, we use 256 hidden nodes in each dense layer of FIG. 11. The value of τ of FIG. 12 is taken to be 5 time slots. The AoT threshold is set to be 15 time slots.

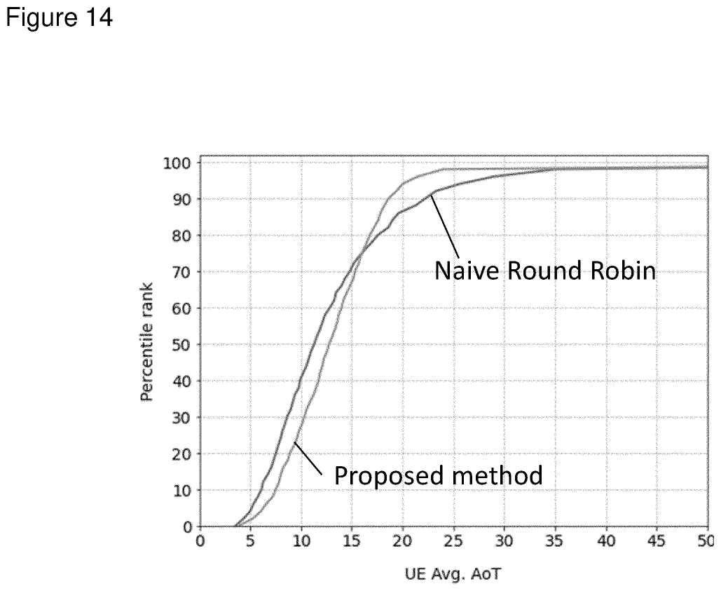

FIG. 13 illustrates the UE goodput (over all the 5 independent drops) of the worst-off UEs for the two considered schemes for the 5^{th} percentile and the 10^{th} percentile. FIG. 14 shows the percentiles of the average AoT of the UEs for both the scheduling schemes. The key observations are the following:

The proposed scheme attempts to satisfy the AoT constraint for more users than RR. Although this is not achieved, FIG. 13 shows that nearly 90% of the time, UEs see an average AoT of 17.5, while the baseline only achieves this 80% of the time. With better NN architectures, this may be further improved.

The 5^{th} and the 10^{th} percentile goodputs, which typically correspond to cell-edge UEs, are better under the proposed scheme. The method may provide a fairer scheduling alternative to current methods.

An apparatus for a distributed unit may comprise means for determining a state vector for a given time slot for a given cell, means for determining a predicted number of spatial layers for a plurality of user equipments for the given time slot based on the determined state vector, means for determining a set of the plurality of user equipments based on the predicted number of spatial layers and the determined state vector, means for co-scheduling the determined set of the plurality of user equipments, means for receiving data from the plurality of co-scheduled user equipments and means for determining a reward metric based on the number of correctly received bits from the plurality of co-scheduled user equipments and a set of hyper-parameters.

Alternatively, an apparatus for a centralised unt may comprise means for receiving at the centralised unit from a plurality of distributed units, per τ time slots, state vectors, reward metrics and an indication of a set of a plurality of co-scheduled user equipments determined at the distributed unit for τ given time slots, wherein τ is a positive integer, means for determining an updated set of hyper-parameters at the centralised unit based on the received state vectors, the received reward metrics and received set of the plurality of co-scheduled user equipments and means for providing, per τ time slots, the updated set of hyper-parameters from the centralised unit to the plurality of distributed units.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims.

Indeed, there is a further embodiment comprising a combination of one or more embodiments with any of the other embodiments previously discussed.

1. An apparatus for a distributed unit comprising:
a processor; and
a memory storing instructions, wherein the instructions, when executed by the processor, cause the processor to:
determine a state vector for a given time slot for a given cell, wherein the state vector comprises an indication of at least one of channel state representation, inter-user correlation matrix distance, age of transmission values for the plurality of user equipments and buffer status reports for the plurality of user equipments;
determine a predicted number of spatial layers for a plurality of user equipments for the given time slot based on the determined state vector;
determine a set of the plurality of user equipments based on the predicted number of spatial layers and the determined state vector;
schedule the determined set of the plurality of user equipments;
receive data from the plurality of co-scheduled user equipments; and
determine a reward metric based on the number of correctly received bits from the plurality of co-scheduled user equipments and a set of hyper-parameters.

2. (canceled)

3. The apparatus according to claim 2, wherein the age of transmission value defines a time period since the last data packet to be transmitted by a UE was generated.

4. The apparatus according to claim 1, wherein the instructions cause the processor to update the set of hyper-parameters at the distributed unit per time slot.

5. The apparatus according to claim 1, wherein the instructions cause the processor to:
provide, per τ time slots, the determined state vectors, the determined reward metrics and an indication of the determined set of the plurality of user equipments for τ given time slots to a centralised unit, wherein τ is a positive integer; and
receive, per τ time slots, an updated set of hyper-parameters from the centralised unit, wherein the updated set of hyper-parameters is based on the determined state vectors, the determined reward metrics and determined set of the plurality of co-scheduled user equipments provided to the centralised unit.

6. The apparatus according to claim 1, wherein to determine the predicted number of spatial layers includes using a machine learning model configured to determine the predicted number of spatial layers for the given time slot based on the determined state vector for the plurality of user equipments.

7. The apparatus according to claim 6, wherein the machine learning model comprises a neural network.

8. The apparatus according to claim 1, wherein to determine the set of the plurality of user equipments comprises using a machine learning model to determine the set of user equipments based on the predicted number of spatial layers and the determined state vector.

9. The apparatus according to claim 8, wherein the machine learning model comprises a recurrent neural network or a gated recurrent unit.

10. The apparatus according to claim 8, wherein the machine learning model comprises a two-stage neural network architecture with a feed forward network determining the spatial stream selection in the first stage followed by a recurrent neural network realised as a custom gated recurrent unit in the second stage determining the set of the plurality of user equipments.

11. The apparatus according claim 6, wherein the determined state vector and the determined reward metric are used as training data for the machine learning model.

12. The apparatus according to claim 1, wherein to co-schedule the determined set of the plurality of user equipments includes to determine a modulation and coding scheme for the determined set of user equipments; and
to request the co-scheduled user equipments includes using the determined modulation and coding scheme.

13. An apparatus for a centralised unit comprising:
a processor; and
a memory storing instructions, wherein the instructions, when executed by the processor, cause the processor to:
receive at the centralised unit from a plurality of distributed units, per τ time slots, state vectors, reward metrics and an indication of a set of a plurality of co-scheduled user equipments determined at the distributed unit for τ given time slots, wherein τ is a positive integer;
determine an updated set of hyper-parameters at the centralised unit based on the received state vectors, the received reward metrics and received set of the plurality of co-scheduled user equipments; and
provide, per τ time slots, the updated set of hyper-parameters from the centralised unit to the plurality of distributed units.

14. A method comprising, at a distributed unit:
determining a state vector for a given time slot for a given cell, wherein the state vector comprises an indication of at least one of channel state representation, inter-user correlation matrix distance, age of transmission values for the plurality of user equipments and buffer status reports for the plurality of user equipments;
determining a predicted number of spatial layers for a plurality of user equipments for the given time slot based on the determined state vector;
determining a set of the plurality of user equipments based on the predicted number of spatial layers and the determined state vector;
co-scheduling the determined set of the plurality of user equipments;
receiving data from the plurality of co-scheduled user equipments; and
determining a reward metric based on the number of correctly received bits from the plurality of co-scheduled user equipments and a set of hyper-parameters.

15-19. (canceled)

20. The method according to claim 14, wherein the age of transmission value defines a time period since the last data packet to be transmitted by a UE was generated.

21. The method according to claim 14, comprising updating the set of hyper-parameters at the distributed unit per time slot.

22. The method according to claim 14, comprising providing, per τ time slots, the determined state vectors, the determined reward metrics and an indication of the determined set of the plurality of user equipments for τ given time slots to a centralised unit, wherein τ is a positive integer; and
receiving, per τ time slots, an updated set of hyper-parameters from the centralised unit, wherein the updated set of hyper-parameters is based on the determined state vectors, the determined reward metrics and determined set of the plurality of co-scheduled user equipments provided to the centralised unit.

23. The method according to claim 14, wherein determining the predicted number of spatial layers includes using a machine learning model to determine the predicted number of spatial layers for the given time slot based on the determined state vector for the plurality of user equipments

24. The method according to claim 14, wherein determining the set of the plurality of user equipments includes using a machine learning model to determine the set of user equipments based on the predicted number of spatial layers and the determined state vector.

25. The method according to claim 23, wherein the machine learning model comprises a two-stage neural network architecture with a feed forward network determining the spatial stream selection in the first stage followed by a recurrent neural network realised as a custom gated recurrent unit in the second stage determining the set of the plurality of user equipments.

26. The method according to claim 14, wherein co-scheduling the determined set of the plurality of user equipments includes to determining a modulation and coding scheme for the determined set of user equipments; and
requesting the co-scheduled user equipments includes using the determined modulation and coding scheme.
